(19) United States
(12) Patent Application Publication
(10) Pub. No.: US 2005/0051473 A1
(43) Pub. Date: Mar. 10, 2005

(54) Rotating filter system

(76) Inventors: Wolfgang Suss, Sonthofen (DE); Hans-Peter Schmid, Sonthofen (DE); Detlef Steidl, Sonthofen (DE); Jurgen Maurer, Sonthofen (DE); Joseph Tichy, Sonthofen (DE)

Correspondence Address: BAKER & BOTTS, 30 ROCKEFELLER PLAZA, NEW YORK, NY, 10112, US

(21) Appl. No.: 10/480,316

(22) PCT Filed: Jun. 12, 2001
(86) PCT No.: PCT/EP01/06654

(51) Int. Cl. B01D 33/00

(52) U.S. Cl. 210/345

(57) ABSTRACT

The invention relates to a rotating filter system, comprising a filter housing (110, 210, 310) and a filter rotor (112, 212, 312) which can rotate therein, having filter cells (136′, 136″) with inserted filter means (138) provided in the rotor casing unit (128) thereof in order to filter out the proportion of solids as a filter cake (FK), for instance, from a suspension supplied thereto and in order to evacuate the filtrate via discharge lines (142, 242). The filter rotor (112, 212, 312) can be driven by a drive motor (154b, 254b) via a gear unit (154, 254, 354) with at least one output member (154d, 254d) which is connected to the filter rotor (112, 212, 312). In order to increase filter output, the output member (154d, 254d) is supported in a stationary manner in a bearing element (111, 211, 311) for said output member, which is separate from a rotor bearing element (225, 325) or/and the output member (154d, 254d) is driven by a group of wheels which are distributed around the periphery of the output member (154d, 254d) in such a way that the radial components of the forces of the driving wheels which are transmitted to the output member (154d, 254d) are canceled out.

The invention relates to a rotating filter system, comprising a filter housing having a housing casing unit, a filter rotor with a rotor casing unit accommodated within the filter housing and capable of rotating about a rotor axis, an interspace between the rotor casing unit and the housing casing unit, where the rotor casing unit has a plurality of filter cells or filter cell groups following one another in the peripheral direction, where additionally in separate filter cells a supply space opening toward the interspace is in each instance separated by a filter means from a discharge line system rotating with the filter rotor, to which in turn a stationary discharge line system is connected downstream via a rotating connection assembly, where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line, where additionally the filter rotor is supported by a rotor bearing and this rotor bearing is supported stationary by a rotor bearing element, where additionally the filter rotor is capable of being driven by a drive motor via a gear unit, which has an output member located substantially coaxial with the filter rotor and connected with the filter rotor for common rotation about the rotor axis.

In particular, the invention concerns rotating filter systems in which for the filtering operation a pressure is built up on the filter material in the interspace, for example by hydrostatic supply pressure or by additional supply of pressure gas or by pumps, and in which the filtrate is evacuated through the filter cells via the rotating discharge line system, the rotating connection assembly and finally through the stationary discharge line system. Passage of one or more wash media, for example a wash liquid or a drying gas or the like, may be effected in similar fashion.

A filter system of this type is disclosed for example in German Patent 878,795 and in the printed source BHS-FEST-Druckfilter bearing the imprint h-2/2-94. In such systems, it is alternatively possible that for performing or supporting the filter operation via the stationary discharge line system, the rotating connection assembly and the rotating discharge line system, a negative pressure is applied to the downstream side of the filter means.

In the known rotating filter system of German Patent 878,795, the filter rotor is supported by hollow shafts in hollow shaft bearings, which in turn are supported by supports stationary and separate from the supporting element of the filter housing. On one of the hollow shafts, i.e., at one end of the rotating filter system the rotating connection assembly is located; at the other end of the rotating filter system the large gear wheel of a spur gear is located on the other hollow shaft. This large gear wheel is driven by a pinion, which is supported separately. Not only is a torque transmitted by the tooth engagement between the pinion and the large gear wheel; but also considerable radial forces which are not always completely absorbed by the bearing of the associated hollow shaft, are also produced so that deformation forces are introduced into the filter rotor, which may result in stress peaks in the structure of the filter rotor. It is therefore necessary to construct the filter rotor very sturdy, so that it is capable of withstanding the pressures in the interspace. Put another way, when the filter rotor is produced in a light structure, which is desirable for reasons of cost, the pressures that may be built up in the interspace must be limited in order to prevent harmful stress peaks on the filter rotor. This means that the throughput performance of the rotating filter system must be limited.

In the design of a pressure filter system disclosed in the printed source BHS-FEST-Druckfilter h-2/2-94, the pressure filter rotor is supported by means of two hollow shafts by slide bearings in bearing brackets, which are flanged onto the filter housing. Located on one hollow shaft is the central part of a rotating connection assembly; located on the other hollow shaft, i.e., near the other end of the filter housing, is the large wheel of a spur gear. Owing to the engagement of a driving pinion with this large wheel, in addition to the torque, radial forces are also introduced into the supporting shaft, which place a burden on the filter drum as well as the filter housing, which via the bearing bracket represents the supporting element for the associated slide bearing. In other words, in this embodiment as well it must be expected that additional stresses are introduced into the filter drum and into the filter housing, i.e., in addition to the stresses that are attributable to the operating pressure and the operating temperature. Hence stress peaks that lie far above the stresses necessarily produced by operating pressure and operating temperature may be developed. Because of the risk of the occurrence of such stress peaks, the operating pressure and operating temperature must be limited.

The invention is based, in addition to other problems, on the problem of increasing the filter output without substantially strengthening the structure of the filter rotor and of the filter housing.

To accomplish this object the use of at least one of the following two feature groups is provided:
a) the output member of the gear unit is supported in an additional bearing, in the following called “output member bearing,” which is supported stationary by an output member bearing element, separate from the rotor bearing element;
b) the output member is driven by a group of driving wheels, which are distributed around the periphery of the output member in such a way that the radial components of the forces transmitted to the output member are at least partially canceled out.

Use of the feature group a) makes it possible for radial forces on the output member, which for example are produced by the tooth engagement between the pinion and the large gear wheel, to be absorbed by the bearing of the output member and carried off by the bearing element of said output member bearing without these supporting forces being able to take the path through the filter rotor or the filter housing. Hence, stress peaks, built up by radial forces in the drive and by simultaneous pressure and/or temperature effects on filter rotor housing as well as the filter housing, are avoided in the filter rotor as well as in the filter housing. The absence of harmful influences from the radial forces of the drive means that pressure and temperature may be increased without building up harmful stress peaks, so that thanks to higher pressure, the output can be increased.

Feature group b) makes it possible for the radial forces produced by tooth engagement of the individual drive wheels to be mutually compensated or at least partially compensated, so that this measure also allows stress peaks in the filter rotor and/or the filter housing to be reduced and, put another way: at a given sturdiness of the filter rotor and the filter housing, the pressures and temperatures in the interspace may be increased, resulting in higher output.

The bearing forces of the rotor bearing may be introduced via the rotor bearing element and the bearing forces of the output member bearing may be introduced via the output member bearing element into a common foundation or into a base frame. Considerable demands are placed on the rigidity of this foundation or the base frame, in order to prevent forces from being introduced anew into the filter rotor and/or into the filter housing due to deformation of the foundation or base frame The separate supporting element of the output member bearing proposed according to feature group a) may be realized for example in that the gear unit comprises a rigid gear housing, in which the gear output member is also supported and in that this gear housing is supported stationary by a gear housing supporting element.

The gear unit may be designed with at least one planetary gear stage; this idea is also to be given independent protection according to Claim 39. Suitable planetary gears are described in for example a catalog of the firm of A. Friedrich Flender A G, Bocholt titled “PLANUREX 2.” This catalog bears the imprint K 256 DE/EN/FR 7.99. When the gear output member is part of the planetary gear stage, the condition of feature group b) of Claim 1 can easily be met by uniform distribution of the planetary wheels around the periphery of the sun wheel.

In the design according to the invention, it is possible that the rotor bearing is at least in part fastened to the gear housing and is supported stationary by means of the gear housing, as is disclosed for example in the catalog “BHS-FEST-Druckfilter” of BHS-Sonthofen bearing the imprint h-2/2-94, without harmful supporting forces being introduced into the filter housing and so an increase in the sturdiness of construction or a reduction in working pressures does not become necessary.

However, it is alternatively possible that according to for instance German Patent 878,795, the rotor bearing is supported by a rotor bearing element that keeps the filter housing substantially free of supporting forces.

There, the support of the rotor bearing may be realized in that the rotor bearing has a bearing point in each of the end regions of the filter housing spaced apart along the rotor axis. However, it is alternatively possible that the rotor bearing be limited to the end region of the filter housing near the gear unit. Then one speaks of a “flying bearing.” Such a flying bearing is desirable especially when it is intended, for example for reasons of easier access to the interior of the filter housing and to the filter rotor, to permit displacement of the filter housing with respect to the filter rotor in the direction of the rotor axis. This aspect will be gone into later.

In the embodiments disclosed in German Patent 878,795 and the BHS printed source h-2/2-94, the rotor is supported capable of rotation by slide bearings. The use of slide bearings is a measure frequently applied in heavy machine construction, which by and large has been proven to be satisfactory, because thanks to the large area of contact within a slide bearing relatively small unit pressures per area result. It has now been recognized that in the construction of rotating filter systems rolling bearings may alternatively be used with advantage. In the construction of rotating filter systems, although resulting in fairly great pressures per unit of area of the components involved nevertheless provide the advantage that the impacts of tipping on occurrence of radial bearing forces and bending moments, as well as wear of the bearing, are reduced. This idea is also to be given independent protection according to Claim 40. Concerning reduction of the risk of tipping, reference should be made to the fact that the use of rolling bearings in the case of the invention has resulted in a reduction of wear phenomena. The reduction of wear phenomena is important not only because the life of the bearings from replacement to replacement or repair to repair is increased, but also because bearing play caused by wear during operation, which may result in insufficient locking in position of the filter rotor with respect to the filter housing, is avoided. Such undefined positionings are therefore very unfavorable because the sealing conditions at the filter cells as well as at the bearings become uncontrollable. When according to the invention rolling bearings are used, not only are better sealing conditions produced over the long term at the boundaries of the interspace zones, but sealing of the whole system becomes more readily possible, including at the bearings themselves. Improved sealing conditions have the result that the higher pressures in the interspace between filter rotor and filter housing sought in order to increase output can be used without the quality of the seal between successive interspace zones required for the process suffering. It also becomes more readily possible to improve the overall sealing of the filter system, especially in the region of the passageways and bearings, so that in the event of working with toxic media the risk of escape of such media is reduced or prevented.

Ball bearings, roller bearings, spherical roller bearings and in particular tapered roller bearings as well may be used as rolling bearings. Especially suitable in the event that instantaneous loads are to be expected are grooved ball bearings, angular ball bearings, especially single-row angular ball bearings or tapered roller bearings fitted in X or even better in O arrangement.

The introduction of radial forces and tipping moments into the bearing points of the filter rotor may also be reduced further in that the output member of the gear unit is connected to the filter rotor by a compensating coupling, flexible at least in the direction orthogonal to the rotor axis. Such a compensating coupling may be designed for example as a pair of membrane couplings with connecting cylinders lying between the individual couplings. For this purpose, reference is made to EP 0,462,991 A2.

While in the prior art according to German Patent 878,795 and according to the BHS prospectus bearing the imprint h-2/2-94, torque is introduced into the filter rotor and the rotating connection assembly in various end regions of the filter housing, according to another idea of the invention, to be independently protected by Claim 41, it may be of advantage to provide the rotating connection assembly and the drive at one end of the filter housing, for instance, so that the rotating connection assembly is located in the direction of the rotor axis between the gear housing and the output member bearing, an idea that is to be independently protected according to Claim 42. At the same time, it is especially advantageous that the rotating connection assembly be located on the side of a rotor bearing point of the rotor bearing distant from the filter housing. Then the rotor bearing is brought near to the filter rotor.

While in the prior art of German Patent 878,795 and VHS printed source h-2/2-94, the filter housing is supported near the bottom, it is now recommended that the filter housing supporting element comprise, at least at one end region of the filter housing, a plurality of supporting points distributed approximately uniformly around the periphery of the filter housing, which is to be independently protected by Claim 43. It must be kept in mind that, owing to the friction of the filter rotor on the rotor casing unit in the region of the interspace zones near the boundaries, great torques are to be expected on the filter housing, specifically, moreover, torques that may be distributed in asymmetrical fashion around the periphery of the filter housing. Now when it is proposed here that the filter housing supporting element be supported on a foundation or intermediate frame by a plurality of supporting points distributed approximately uniformly around the periphery of the filter housing, stress peaks in the filter housing, which occur as the result of friction between the filter rotor and the filter housing, may be minimized by this kind of bearing support. Additional minimization of stress peaks, especially at the high temperatures to be expected, becomes possible when at least some of the supporting points are assigned to compensating means for the compensation of variations in diameter of the housing casing unit.

One possibility of realization of the idea of uniform distribution of the supporting means of the housing around the periphery consists in that at each of two supporting points spaced apart along a horizontal diametral line, a supporting column or supporting beam is provided for the filter housing. In such a design, which is to be independently protected by Claim 44, favorable conditions are also provided for the realization of the idea, to be discussed later, of evacuating the filter cake from the interspace in the bottom region of the filter housing, provided that between the supporting columns or supporting beams access to the underside of the filter housing is provided at least one end of the filter housing.

The filter housing supporting element may alternatively have compensating means for variations in length of the filter housing in the direction of the rotor axis, again with the object of avoiding or reducing pressure-induced and especially temperature-induced stresses.

While in the prior art according to German Patent 878,795 and according to printed source BHS-FEST Druckfilter, the interspace between the rotor casing unit and the housing casing unit is sealed off by a stuffing box, according to the invention it is additionally provided that the interspace between the rotor casing unit and the housing casing unit in the vicinity of at least one axial end of the units is capable of being sealed off by a sealing assembly which is capable of being brought into sealing contact with a sealing surface of at least one of the two units by a torus inflatable by means of pressure fluid. This idea is to be independently protected according to Claim 45.

The design of the sealing assembly according to the invention makes it possible to take into account the pressure increase in the interspace, which according to the object formulated at the beginning takes into consideration an increase in the filter output. In particular, even at high pressures a sealing effect may be continuously maintained without need for adjustment, since fatigue of the sealing material is not to be expected. The contact pressure between the sealing assembly and the at least one sealing surface may be selectively adapted to the particular pressure in the interspace. On the other hand, there is the possibility of briefly relieving and again tightening the seal, for instance when the system is to be opened and closed again for repair or maintenance purposes, or when upon replacement of one or more operating media, interim cleaning is to take place.

In the embodiment according to the invention, the sealing assembly may be made largely of synthetic material. This makes it possible to bring into use synthetic materials resistant to the respective filter material and treatment media. Thanks to production of the sealing assembly of synthetic material, the lubricated braids unavoidable in conventional stuffing box packings, in which the risk of detachment from the packing material occasionally existed, are absent. The pressure fluid may be checked constantly for its operating pressure and adjusted to its desired sealing effect; there is no need for periodic replacement of a stuffing box packing.

Insofar as with use of sealing assemblies based on synthetic material, lubrication is still necessary, use may be made of homologous liquids for lubrication, i.e., liquids that are related to the filter material or/and to the associated treatment fluids since risk of contamination is reduced on the basis of relationship alone. In the case of aqueous productions, i.e., for example filter material in the form of an aqueous suspension, water may be used as the lubricating agent.

The sealing assembly may be connected stationary to the housing casing unit and be capable of being pressed against a sealing surface rotating with the rotor casing unit; it may for example be designed as a groove profile substantially unshaped in cross section, which is fixed with respect to the housing casing unit by a first U arm, capable of being pressed sealingly by a second U arm against a sealing surface of the rotor casing unit, and between the two U arms accommodates a toric inflated member, which is located stationary on the housing casing unit and is connected to a pressure fluid source. In such an embodiment, owing to the inflation pressure of the inflation member, the sealing element may be adjusted against the housing casing unit as well as against the filter rotor. The U cross piece connecting the two arms of the U together advantageously is placed on the inside, so that the U opens towards the outside. The accessibility of the inflation member and the connections to be attached to it for connection to the pressure fluid source is thus improved without adversely affecting sealing effectiveness.

The sealing assembly may be attached to an end ring of an approximately cylindrical frame of the filter housing, where on this end ring at least one plain or/and cylindrical contact surface may be provided for the sealing assembly.

As disclosed in the printed source BHS-FEST-Druckfilter, the filter housing may have an approximately cylindrical skeleton frame. There, this skeleton frame may be made of a plurality of skeleton rings and skeleton rods running parallel to the axis of rotation between the skeleton rings, where in the simplest case in relatively short filter systems two terminal skeleton rings are provided. The skeleton frame forms a basic structure of the housing casing unit. Skeleton windows are produced between successive skeleton rods. Fillers may be inserted in these skeleton windows. There, the fillers serve on the one hand for completion of the skeleton frame to form a pressure-resistant housing that in the various interspace zones resists the pressure of the filter material and the various treatment media. At the same time, the fillers may act as supports of additional functional parts of the filter system, for example as supports of connecting fittings of the stationary supply line system, through which filter material and treatment medium may be introduced into the respective interspace zones. In addition, the skeleton windows are divided for accommodation of the zone separating means between successive interspace zones in the peripheral direction, which accordingly are also to be understood as fillers.

It is desirable that the dimensions of the skeleton windows be standardized and that at least some of the windows have approximately like angular distances, so that individual skeleton windows may be equipped with a variety of fillers, i.e. for example fillers that act as zone-separating means or fillers that are designed for the connection of lines of the supply line system. In this way it is possible, by replacement of fillers, to adapt a given basic design of the filter system to a variety of filter tasks, in particular with regard to the division of zones.

Although the basic part of the filter housing formed by the skeleton frame and the fillers is already inherently pressure-resistant, an additional covering element, which may be limited to particular regions of the outer periphery but which may alternatively extend over the entire surface of the housing casing is often desired. This covering element may assume a wide variety of functions. Thus, particular functional parts that are assigned to particular regions of the housing casing unit, for example fittings of the supply line system, may be attached to the covering element. In addition, the covering element may assume functions of mechanical stiffening of the housing casing unit, of additional sealing and of improvement in appearance. The covering may be designed in such a way that a cover is assigned to at least one skeleton window. These covers may be supports of functional parts of the filter system, for example fittings, which may if desired cooperate with a filler or an additional functional part of the filter system carried by a filler. At the same time, it is possible that such a cover be limited to the covering of a single filler; however, it is alternatively possible that a cover be designed to cover a plurality of fillers.

With regard to the fact that functional parts requiring maintenance and/or repair, namely either the fillers themselves or additional functional parts attached to the fillers, are concealed by a cover, to facilitate access for maintenance and repair work, it is recommended that a cover be securable to the skeleton frame by linking or/and fastening means for easy operation. Operation/use is particularly facilitated when linking means, which permit simple swinging away of a cover, are provided.

It is alternatively possible that the cover be securable to a filler by articulating or/and fastening means. In this case, the cover may easily be installed and removed with the respective filler. However, if only minor maintenance work is required on functional parts located on the respective filler, for example fittings, the filler may be left in place in the skeleton frame and the cover swung away from the respective filler for making these functional parts accessible. Depending on the shape of the filter housing, it is advisable to design any articulation of the cover—regardless of whether on the skeleton frame or on the filler—with a pivot axis that is parallel to the axis of the filter rotor.

In the rotating filter system according to the invention, it is possible largely to eliminate the escape of media of the filter process, i.e. of the filter material and the treatment medium. This is a result in particular of sealing by the sealing assembly according to the invention and improved sealing between the fillers and the skeleton windows. In addition, the sealing element may optionally be constructed or supplemented by a closed covering, improved or made even more secure by individual covers.

For sealing of the rotor casing unit, a critical region is the seal between the fillers, in particular the fillers designed as zone-separating means, on the one hand, and the framing region of the skeleton windows accommodating the fillers on the other.

This seal may be designed secure in the region of the zone-separating means in that a zone-separating means is made of a separating plate on whose side distant from the rotor casing unit rests a membrane acted on by pressure fluid or/and a cushion acted on by pressure fluid. In particular, a membrane acted on by pressure fluid can surely prevent the escape of process medium from the interspace, even if the upstream sealing means, i.e. sealing means near the interspace, should fail or allow leakage. In addition, the membrane may be acted on by pressure from the outside, so that with the intermediary of the membrane the contact pressure of the zone-separating means, i.e. for example a separating plate against the cell structure of the rotor casing unit, may be effected. A cushion acted on by pressure fluid may alternatively be used for pressing the zone-separating means against the cell structure of the rotor casing unit and at the same time take over sealing tasks for the process media. The combination of a membrane and a cushion acted on by pressure fluid provides optimal conditions.

The zone-separating means as a rule have an elongated shape in the direction of the rotor axis; one speaks of a separating plate. This separating plate may be designed with a strip as support and with a sealing layer applied to the strip as a coating. The sealing layer may be designed for contact to the cell structure of the rotor casing unit as well as for contact to the boundary of the skeleton window, so that the tight separation of the interspace zones from one another, on the one hand, is ensured and, on the other, the escape of process medium thorough the housing casing unit is prevented. The strip may be made of synthetic material. On the one hand, a savings of weight and easier handling in installation and removal of the respective separating plate is thereby obtained. On the other, the synthetic material may be selected as required for adaptation to the process media to be expected for the particular use, in order to obtain high tightness and long service life of the respective separating plate.

With regard to sealing of the interspace, the border between the individual filter cells and the filter means assigned to the respective filter cell is also critical. It is proposed that the filter means assigned to the filter cell comprise a supporting frame sealed off on its periphery against a cell-enclosing wall, preferably a supporting frame of synthetic material, for a filter fabric, screen, or the like, where a sealing ring used for sealing sealingly fills up the interspace between a peripheral surface of the supporting frame and the cell-enclosing wall to approximately the level of a filter-side face of the supporting frame near the periphery. This measure in particular prevents dead corners in the filter cells, in which residues might collect over a long period of time. Avoiding such residues is a special desideratum not only in the replacement of process media, in which a complete cleaning will as a rule be required in any case, but also in batch replacement, i.e. when a new batch of a basically unmodified process medium, in particular filter material, is to be treated.

The idea of complete interspace filling between the supporting frame of the filter means and the cell-enclosing wall is to enjoy independent protection according to Claim 46.

Production of the supporting frame of a filter means of synthetic material also provides a favorable condition for making the filter fabric as metal wire fabric and welding it to the supporting frame.

Reference has repeatedly been made to the problem of maintenance and cleaning of the rotating filter system. This problem may basically be solved by the detailed measures already mentioned in that the filter housing, for at least partial access to the filter rotor, is displaceable relative to the filter rotor in the direction of the axis of rotation. This idea is to be placed under independent protection in Claim 47. The idea of displaceability of the filter housing and the filter rotor relative to one another is basically not tied to the measures of the flying rotor bearing and bearing element treated above, nor to the location of the gear unit and the rotating connection unit at the same end of the filter housing treated above, nor to the abovementioned sealing of the interspace by a sealing assembly with an inflatable torus. However, displaceability between the filter housing and the filter rotor may be greatly facilitated by each one of these measures and especially by the combined use of these measures.

The idea of displaceability of the filter housing and the filter rotor can readily be realized in that the filter housing is conveyed displaceable on a stationary displacing frame, in particular when the filter rotor has flying supports.

According to an additional feature of the invention, it is provided that cleaning nozzles, which are connected to a cleaning fluid supply, are provided in the region of functional parts requiring cleaning. This idea is to enjoy independent protection according to Claim 49.

The provision of cleaning nozzles per se already represents a significant simplification of the especially important cleaning problem in filter systems. In conjunction with the displacabiltiy of the filter housing and the filter rotor relative to one another, as well as in conjunction with the extensive use of synthetic material parts and elimination of dead spaces, a perfect cleaning system is produced. Cleaning of the rotating filter system may be performed without being dependent on the skill and good will of the personnel entrusted with cleaning. The cleaning nozzles may be operated successively with unlike cleaning and drying media. In detail, the cleaning nozzles are in each instance located where the system parts requiring cleaning are most easily reached, be it in the moved-together state of the filter housing and filter rotor, be it after the filter housing and filter rotor are moved apart.

Discharge of the filter cake from the cell structure of the filter rotor may be problematic, especially when the filter cake is in the form of a sticky substance. In order to be able to discharge the filter cake as completely as possible from the respective cells, scrapers have already been developed, which in the respective ejection zone reach into the cells and engage under the filter cakes and scrape them out. The deeper the filter cells, the more difficult the construction and handing of these ejection means. On the other hand, with respect to a high output of the rotating filter system it is desirable to make the cells as deep as possible.

It has been found that in certain cases, the location of the ejection zone in the bottom region, i.e. in the lowest region, of the filter housing is advantageous, because there ejection of the filter cake is optimally supported by the force of gravity. For this reason, it is additionally proposed that a filter cake ejection zone be provided in the lowest region of the housing casing. This measure basically is not tied to the type of supporting means of the filter rotor bearing. It has been found, however, that when the filter cake ejection zone is located in the lowest region of the filter housing its accessibility due to the above-mentioned location of the supporting points for the filter housing at two locations spaced apart along a horizontal diametral line can be considerably improved. Location of the filter cake ejection zone in the lowest region is to enjoy independent protection according to Claim 48.

The basics of the invention and the details of the invention are explained by examples in the accompanying figures, wherein

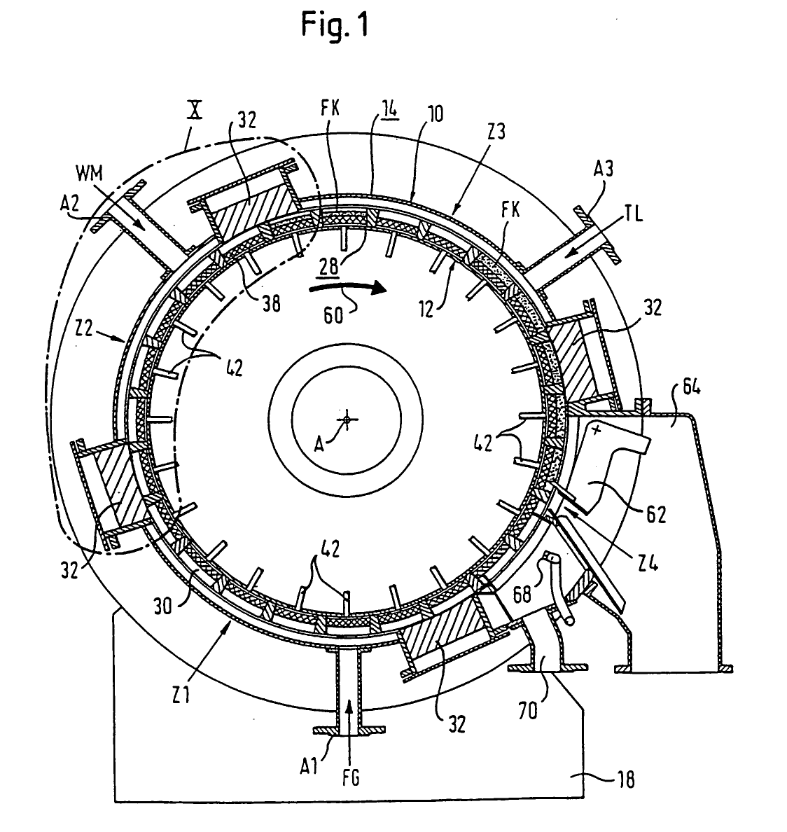

FIG. 1 shows a basic representation of a known rotating filter system in cross section;

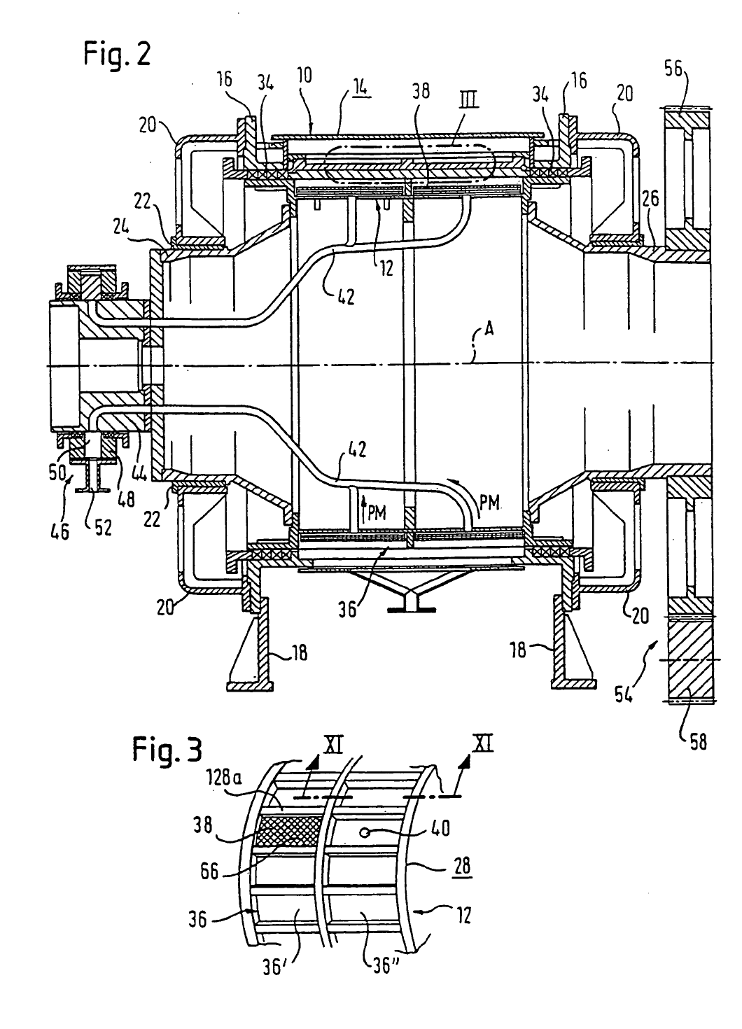

FIG. 2 a cross section through the rotating filter system of FIG. 1;

FIG. 3 a sector in the cell structure of the filter rotor of FIGS. 1 and 2, in the region III of FIG. 2;

FIG. 4 a side view, partially in section, of a rotating filter system according to the invention;

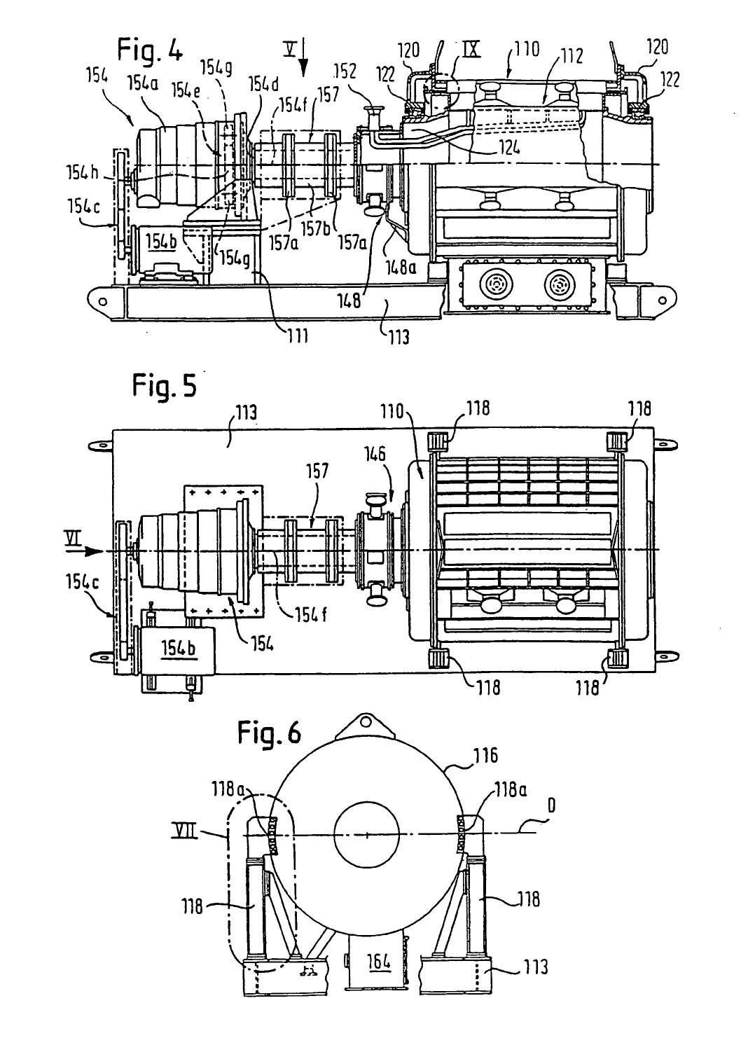

FIG. 5 a top view of the rotating filter system of FIG. 4 in the direction of the arrow V of FIG. 4;

FIG. 6 an additional schematic end view of the rotating filter system of FIG. 5 in the direction of the arrow VI of FIG. 5;

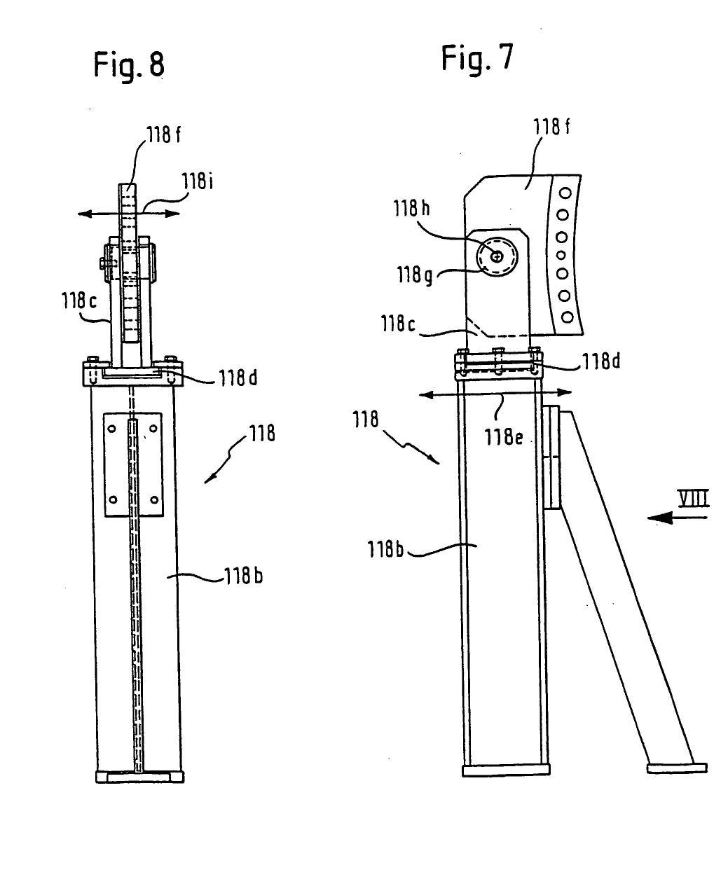

FIG. 7 a detail view of a supporting beam in the region VII of FIG. 6;

FIG. 8 a view of the supporting beam of FIG. 7 in the direction of the arrow VIII of FIG. 7;

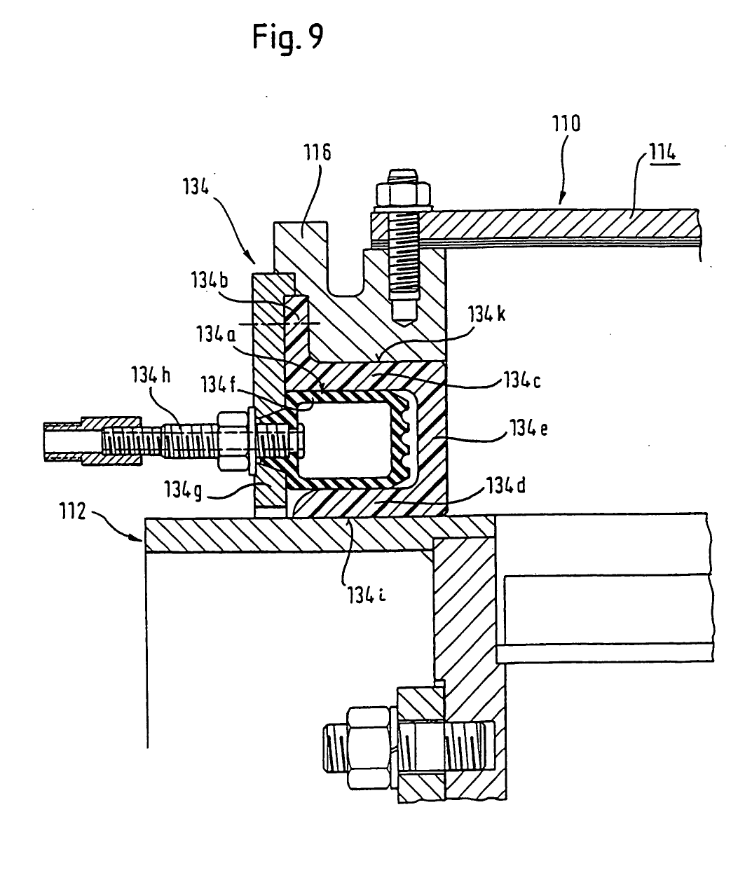

FIG. 9 a sealing assembly according to detail IX of FIG. 4;

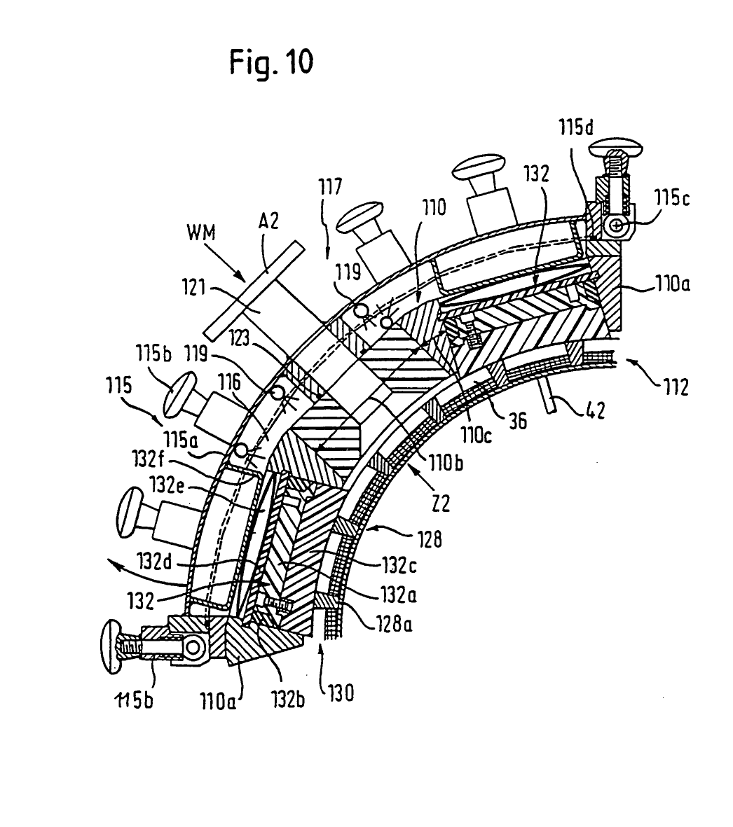

FIG. 10 a peripheral segment of a housing casing unit of the region X of FIG. 1;

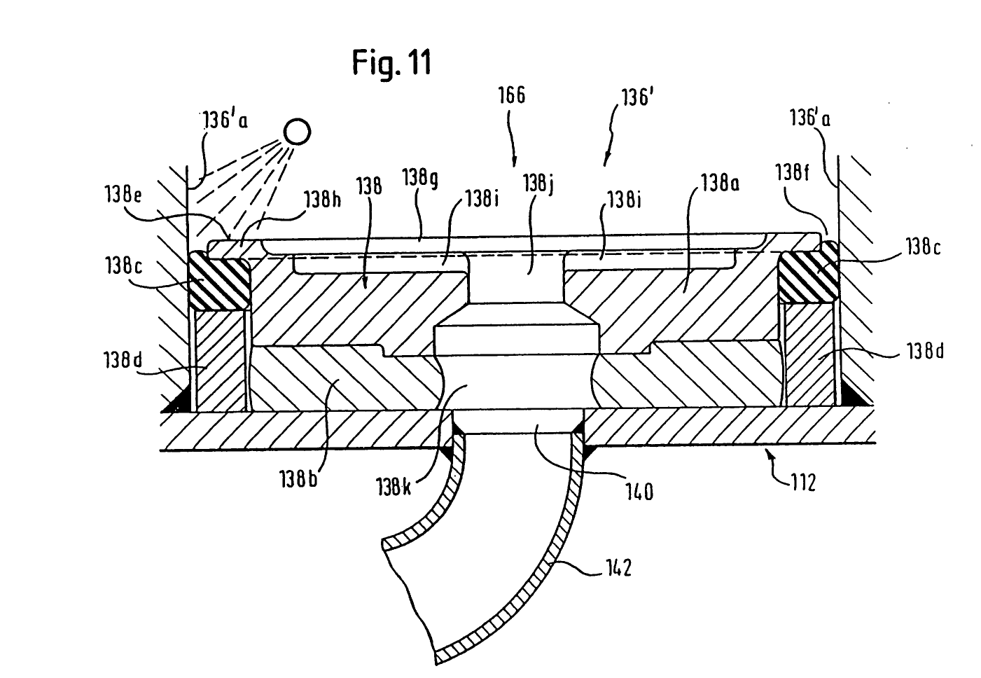

FIG. 11 a filter cell in section along the line XI-XI of FIG. 3;

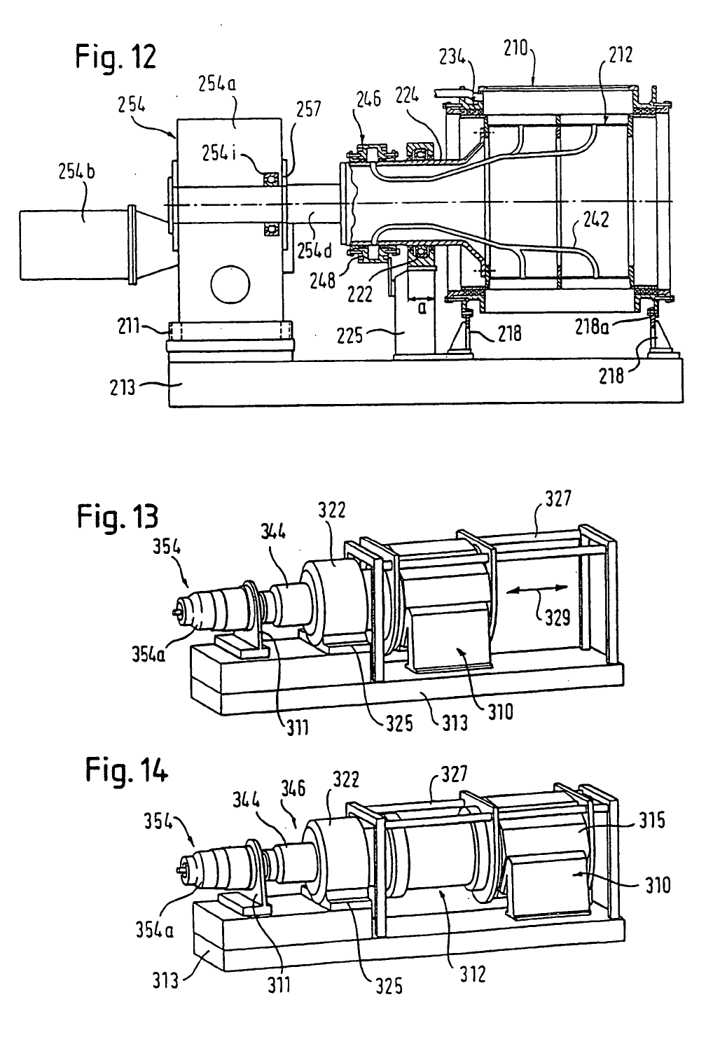

FIG. 12 a side view, partially in section, of an additional example of a rotating filter system according to the invention;

FIG. 13 a perspective view of a third example of a rotating filter system according to the invention with a filter housing displaceable with respect to the filter rotor, in operating position;

FIG. 14 a view of the rotating filter system of FIG. 13 in an inspection and maintenance position.

First of all, let the basic construction and mode of operation of a rotating filter system be described by means of FIGS. 1-3. FIGS. 1-3 come from the printed source BHS-FEST-Druckfilter bearing the imprint h-2/2-94.

In FIGS. 1 and 2, a filter housing is very generally labeled 10 and a filter rotor is very generally labeled 12. The filter housing 10 comprises a housing casing unit 14 with end rings 16. The filter housing unit 14 is supported on a foundation, not represented, by means of a filter housing bearing element 18 to be attached to the end rings 16. Bearing brackets 20, which comprise the rotor bearing 22, are fastened to the filter housing unit 10. The filter rotor 12 is supported in the rotor bearings 22 by mean of two end sections 24 and 26. The filter rotor 12 comprises a rotor casing unit 28. An interspace 30 is defined between the rotor casing unit 28 and the housing casing unit 14. This interspace 30 is divided by zone-separating means 32 into interspace zones Z1, Z2, Z3 and Z4. At its ends spaced apart axially, the interspace 30 is sealed off by sealing assemblies 34. The outside of the rotor casing unit 28 turned toward the interspace 30 is designed as a cell structure, which is represented in FIG. 3. This cell structure comprises filter cells 36′ and 36″, where one filter cell 36′ and one filter cell 36″ in each instance form a filter cell group 36. In each filter cell 36′, 36″ is located a filter means 38, which covers a discharge opening 40. T he discharge openings 40 of the filter cell group 36 are connected by a discharge line 42 rotating with the filter rotor 28 to the core 44 of a rotating connection assembly 46, likewise rotating with the filter rotor 28, the rotating core 44 being arranged fixed against rotation to the end section 24 of the filter rotor 12. In addition, the rotating connection assembly 46 has a rotating connection stator 48, which is supported against rotation on the filter housing 10. As represented in the lower half of FIG. 2, a discharge line 42 leads from each cell group 36 to the rotating connection core 44. Located in the rotating connection stator 48 are located annular segment chambers 50, where the peripheral length of an annular segment chamber 50 corresponds to the peripheral length of one of the interspace zones Z1-Z3. A stationary discharge line 52 leads from each of the segment spacers 50 to a collecting chamber, not represented.

The filter rotor 10 is driven by a gear unit 54. The gear unit 54 comprises a large gear wheel 56 and a drive pinion 58. The drive pinion 58 is driven by an electric motor. The speed of the electric motor is reduced by the gear unit 54 so that the filter rotor 12 rotates at a speed in the order of magnitude of 0.5-4 rpm. The direction of rotation is indicated in FIG. 1 by an arrow 60.

Supply fittings A1-A3 are connected to the interspace zones Z1-Z3. Scrapers 62 are assigned to the interspace zone Z4. In addition, a filter cake ejection compartment 64 is connected to the interspace zone Z4.

The rotating filter system described thus far works for example as follows:

Filter material FG, for example a liquid-solid suspension is supplied through the supply fitting A1 and spreads out in the interspace zone Z1, under hydrostatic pressure. The liquid constituent of the filter material FG is pressed through the filter means 38 of the cells 36′, 36″, so that the solids portion in each instance collects radially outside the filter means 38 as filter cake FK in the supply spaces 66 in each instance and the liquid portion, called filtrate for the special case of the liquid portion of the filter material FG, goes through the discharge openings 40 into the discharge lines 42. The flow of filtrate is indicated in FIG. 2 by an arrow PM. If one imagines FIG. 1 as a momentary picture during the continuous rotating motion of the filter rotor 12, at the corresponding moment all filter cells 36′, 36″, which are radially opposite the interspace zone Z1 and are open toward the latter, are in communication with the supply fitting A1, and, in addition, the discharge openings 40 of these cells 36′, 36″ in communication with the interspace zone Z1 are via a discharge line 42 in each instance connected to the rotating connection core 44, and, in addition, are connected via the rotating connection 46 to the stationary discharge line 52, which leads to a filtrate-collection vessel, not shown. The annular segmented chamber 50, assigned to the interspace zone Z1 is sized so that at the point of time represented by FIG. 1 all cells 36′ and 36″ open toward the interspace zones Z1 are finally connected by their discharge openings 40 to the stationary filtrate-collecting vessel. The liquid contained in the filter material FG and flowing out of interspace zone Zi, is termed the “filtrate.”

When a filter cell group 36 passes by a zone-separating means 32, in the course of further rotation of the filter rotor 12, the cell group 36 is separated from the interspace zone Z1 and after traveling past the zone-separating means 32 goes into communication with the interspace zone Z2. Upon entry of a cell group 36 into the region of the interspace zone Z2, a filter cake FK, via the filter means 38 of the two cells 36′. 36″, has been formed from the solids portion of the filter material FG retained by the filter means 38. This filter cake FK now is to be cleaned in the region of the interspace zone Z2. For this purpose, the interspace zone Z2 is supplied by the supply fitting A2 with a washing agent WM, which is distributed over the entire interspace zone Z2 and penetrates the respective filter cake FK as well as the filter means 38 lying under it, in order then to go through the respective discharge opening 40 into the respective discharge line 42. The discharge lines 42 of all filter cells 36′, 36″, which in momentary picture of FIG. 1 are in communication with the interspace zone Z2 are carried through an annular chamber, not visible in FIG. 2, by a stationary discharge line (not drawn in) to a wash fluid-collecting vessel, to which a separating stage may be added downstream, in order to separate the washed-out liquid constituents in the cake from the wash liquid and to be able to use the washing liquid for a fresh washing operation.

After passage of a cell group 36 through the annular space zone Z2, this cell group 36, after passing the zone-separating means 32 separating the interspace zones Z2 and Z3, goes to the interspace zone Z3. The interspace zone Z3 is supplied by the supply fitting A3 with drying air TL, which is distributed over the entire interspace zone Z3 and can reach each of the cell groups 36, which are opposite the interspace zone Z3. This drying air TL passes through the filter cake FK and the filter means 38 lying under it in each instance and may again reach the rotating connection assembly 46 through the respective discharge openings 40 and in each instance associated discharge line 42. There, the drying air TL is supplied to an additional annular segment chamber (not shown) of the rotating connection stator 48, and may escape into the atmosphere through a stationary discharge line, not shown, into the atmosphere or be conveyed to a separating device, in which the liquid constituents removed from the filter cake FK may be carried out by the drying air TL from the filter cake FK. All cell groups 36 in the momentary picture of FIG. 1 opposite the interspace zone Z3 are in each instance at the same time connected via the additional annular segment chamber of the rotating connection stator 48 to the stationary discharge line for the drying air TL.

If a single cell group 36 is considered during a rotation about the rotor axis, it can be seen that this cell group 36 is successively subjected to the following operations:

Upon entry into the interspace zone Z1, the cell group 36 is filled with filter material FG.

The liquid portions are pressed out of the filter material FG through the filtering means 38, and go into the filtrate collection vessel as filtrate.

After passage through the interspace zone Z1, the filter cake FK that has settled on the floor of the filter cell group 36 is washed after entry into the interspace zone Z2 by the washing agent WM. The spent wash liquid goes through the filter cake FK and through the filtering means 38 lying under it into the filtrate discharge system and then into, for example, the wash-agent collection vessel.

When the filter cake FK washed in the cell group 36 enters the interspace zone Z3, it is dried by the drying air TL introduced through the fitting A3. The drying air TL penetrates the filter cake FK and the filter means 38 lying under it and goes through the associated discharge line 42 and the rotating connection assembly 46 out into the atmosphere or a separator.

When a filter cell 36′, 36″ has traveled through the zone-separating means 32 between the interspace zones Z3 and Z4, the treatment is brought to an end. The filter cake FK may now be ejected. For this purpose, the scrapers 62 are used in the interspace zone Z4, which are supported and controlled in such a way that they successively penetrate one after another into each individual filter cell 36′, 36″, eject the respected filter cake FK and then in time with rotation of the rotor again move back out of the filter cells 36′,36″. It is easy to see that the deeper the cells 36′ and 36″ are, the more complicated the ejection operation and the 62 used to carry it out.

A wash nozzle 68, by which any ejection residues in the cells 36′, 36″ can be washed out of the latter, can also be seen in the interspace zone Z4. The washing fluid that is sprayed out there may be discharged through a washing fluid outlet 70.

The embodiment according to the invention of FIGS. 4 -11 is based upon the structural and working principles of FIGS. 1-3; similar parts are labeled with the same reference numerals as in FIGS. 1-3, in each instance increased by the number 100.

In FIG. 4, the filter rotor 112 is supported by ball bearings 122 in bearing brackets120 attached to the filter housing 110. The drive of the filter rotor 112 driven by a planetary gear unit 154, which is supported by a supporting beam 111 on a base frame 113. The planetary gear 154 comprises a planetary gear housing 154a, which is bolted to the supporting beam 111. The planetary gear 154 is driven by an electric motor 154b via a belt drive 154c. The electric motor 154b is likewise supported on the base frame 113. The planetary gear 154 reduces the speed introduced into it by the electric motor 154b. The slow speed is taken off at an output member in the form of an output shaft 154d. The shaft 154d is connected via a shaft coupling 157 to a rotating connection core 144, which as a continuation of the filter rotor 112 is connected fixed against rotation to the end segment 124 of the filter rotor 112. The shaft coupling 157 is made of two lamella packets 157a of a lamella coupling and cylindrical steel piece 157b connecting the latter, and serves to compensate for alignment errors between the output shaft 154b of the planetary gear 154 and the end segment 124 of the filter rotor 112.

Let it be noted that in this embodiment, in contrast to the known embodiments described with reference to FIGS. 1-3, the drive of the filter rotor 112 is effected from the same left side of the filter housing 110, on which the rotating connection assembly 146 is also located. Let it be noted further that the planetary gear 154 is fastened by a separate supporting beam 111 to the base frame 113. The filter housing 110 is also fastened to this base frame 113, specifically by supporting beams 118 which can be seen in FIG. 6. The base frame 113 has high resistance to torsion, so that the forces of reaction in the planetary gear 154 and in the gear housing 110 can be absorbed by it substantially free of deformation.

The planetary gear 154 is designed with an output stage 154e, which comprises a plurality of planetary wheels 154g distributed uniformly around the periphery of the planetary gear axis 154f, so that radial forces, which may perhaps arise at the point of engagement between the planetary wheels 154g and a central wheel 154h connected with the takeoff shaft 154d, are mutually compensated. Therefore, no substantial radial forces are transmitted from the planetary gear 154 to the filter rotor 112, and therefore asymmetric loads on the filter rotor 112 are not produced on the filter housing 110.

Even if radial forces were to develop in the planetary gear 154, which continue as far as the takeoff shaft 154d, these would be absorbed by the gear housing 154a and introduced into the base frame 113 through the supporting beam 111; accordingly they are unable to produce any asymmetrical loading of the filter rotor 112 and the filter housing 110. The shaft coupling 157 does the rest, in order to relieve the filter rotor 112 and hence also the filter housing 110 of asymmetrical radial forces. The rotating connection stator 148 is secured by a torque support 148a at the bearing bracket 120 against rotating along with the filter rotor.

The filter housing 110 is supported on the base frame 113 by the aforementioned supporting beams 118. These supporting beams 118 are connected at two supporting points 118a with the filter housing 110, specifically in the case of the example by the end rings 116 of the filter housing. Each of the two end rings 116 is assigned a pair of supporting beams, as shown in FIG. 6. It can be seen that the supporting points 118a lie diametrically opposite one another along a horizontal diametral line D, i.e. are uniformly distributed at 180° distances apart around the periphery of the filter housing 110. High supporting forces are introduced via the supporting beams from the filter housing 110 into the base frame 113. The high supporting forces derive in particular from the drag moment that the filter rotor 112 exerts on the filter housing 110 at the zone separating means 132 (see FIG. 10). The supporting forces resulting from this high drag moment are to some degree symmetrically transmitted by the position of the supporting points 118a in opposition along the diametral line D to the filter housing 110, so that the load of the filter housing 110 is symmetrical in every case-as in the embodiment of FIGS. 1 to 3—only a single supporting element 18 is present in the floor region of the filter housing.

An additional feature of the supporting element of the filter housing 110 lies in that compensating means for the compensation of variations in diameter of the filter housing 110 are provided in the supporting beams 118. These compensating means are represented in detail in FIGS. 7 and 8. It can be seen that a supporting beam 118 is composed of the lower part 118b of a supporting beam to be connected with the base frame 113, and an upper part 118c of a supporting beam, which are joined together by a sliding connection 118d, where this slide connection 118d permits displaceability of the two beam parts 118b and 118c relative to one another in the direction of the arrow 118e. A variation in diameter of the filter housing 110 is accordingly compensated for in the sliding connection 118d.

If it is considered that high temperatures of the filter material may occur the possibility of an extension in length of the filter housing 110 must also be expected. For this reason, length compensating means are provided on at least one of the two supporting beam pairs 118-118′. The flange 118f, which is designed for connection to the end ring 116 of the filter housing 110, is supported capable of rotation by an articulated joint 118g on a joint bolt 118h and is displaceable in the direction of the arrow 118i.

It can be seen in FIG. 6 that the cake ejection compartment 164 is located approximately at the bottom region of the filter housing 110. However, good access to this compartment 164 is possible, thanks to the lateral position of the supporting beam 118.

An additional feature of the design according to the invention of the rotating filter system according to the invention lies in sealing of the interspace 130. While in the rotating filter system of FIGS. 1-3, belonging to the prior art, stuffing box arrangements are indicated as sealing elements at the ends of the interspace 30, spaced axially apart in the embodiment according to the invention described in FIGS. 4 to 11, the sealing assembly that is represented in detail in FIG. 9 is used. According to FIG. 9 the sealing assembly 134 is located fixed against rotation at one end ring 116 of the filter housing 110. The sealing assembly 134 comprises an annular member 134a with U profile, which is fastened by means of a fastening flange 134b to the end ring 116 and has two U arms 134c and 134d so that the U cross piece 134e is turned toward the zone separating means. Between the two U arms 134c and 134d is accommodated a toric expansion member 134f, which is fastened via a cover plate 134g to the end ring 116 and is connected through the latter to an inflation fluid connection 134h. By inflation of the member 134f upon supply of pressure means, the U arm 134d is applied sealingly against a cylindrical sealing surface 134i, while the U arm 134c simultaneously is applied tightly against a sealing surface 134k of the end ring 116. Here, a practically maintenance-free seal is obtained. The annular member 134a is made of synthetic material, for example of polyamide. In detail, the selection of the synthetic material is made in adaptation to the process media present in each instance, so that the synthetic material is as resistant as possible to the latter. The sealing point between the sealing surface 134e and the U arm 134d may be cooled by a fluid and and/or lubricated by a fluid which is related to the respective process medium.

Details of the design of the filter rotor 110 and the filter housing 112 according to the invention can be seen in the detail of FIG. 10 corresponding to the partial region X of FIG. 1.

The two together form the interspace 130.

The filter housing 110 is made up of the end rings 116 and the skeleton rods 110a, which together form a skeleton frame 116-110a. In each instance between each two skeleton rods 110a following one another in the peripheral direction are formed skeleton windows 110b, at least some of which have like internal dimensions. The distances apart 110c between successive skeleton windows 110b preferably are also alike.

Fillers that perform a variety of functions may be inserted into the skeleton windows 110b. In FIG. 10, a first group of fillers can be seen, which are designed as zone-separating means 132. In detail, these zone-separating means 132 are made up as separating plates with a strip 132a of synthetic material. In this connection, the synthetic material is selected so that it is resistant to the respective process medium, that is, in particular to the filter material FG. The strip 132a is provided with a sealing cord 132b running all around, which rests against the inner periphery of the skeleton window 110b. The side of the strip 132a turned toward the filter rotor 112 is attached a sealing layer 132c, which again may be made of synthetic material, and is designed for contact against the inner peripheral surface of the skeleton window 110b and against the top of ribs 128a of the cell structure represented in FIG. 3.

In addition to the sealing cord 132c, an additional sealing function may be exercised by a sealing membrane 132d, which rests on the radial outer side of the strip 132a and is tightly anchored in the peripheral surface of the respective skeleton window 110b. In order to produce a good seal between the interspace zone Z2 of the interspace 130 represented in FIG. 10, and the adjacent interspace Z1 (see FIG. 1), the strip 132a with the sealing layer 132c must be pressed against the tops of the ribs 128a. For this purpose, a cushion 132e which is provided with a fitting, not represented, for the introduction of an inflation fluid and which is supported at its radial outer side against a supporting box 132f lies over the sealing membrane 132d. The supporting box 132f is fastened to a covering element 115, which is to be gone into in detail below. The contact pressure of the sealing layer 132c against the tops of the ribs 128a and hence the separating and sealing effect between successive interspace zones Z1-Z4 may be specified by corresponding determination of the fluid pressure in the cushion 132d. There, the membrane 132d is kept so slack that it does not substantially influence the amount of contact pressure against the top of the ribs 128a. In this way, it is secured that successive interspace zones Z1, Z2 and Z3 are constantly optimally separated from one another, even when unlike pressures prevail in successive interspace zones Z1, Z2, Z3 and when the positioning of the filter rotor 112 has lost accuracy due to wear of the rotor bearing 122.

In FIG. 10 as an additional filler, a fitting filler 117 is represented, which connects to the connection fitting A2 for the wash medium. This fitting filler 117 may also be made of a synthetic material resistant to the respective process medium and be sealed off against the inner peripheral surface of the respective skeleton window 110b.

In FIG. 10, a plurality of spray nozzles 119 may also be seen, some of which are fastened to the skeleton frame 116-110a, some to the covering element 115. The covering element 115 as a whole may be designed as a tight covering element, which forms an additional protection against the escape of process medium, namely in addition to the sealing element that already exists through the skeleton frame 116-110a and the fillers 132 and 117 inserted into the skeleton frame 116-110a. In the case of the example of FIG. 10, the covering element 115 is attached by covering segments 115a, which are individually are attached to the skeleton frame 116-110a and are fastened by quick closures 115b. Thanks to the quick closures 115b, the covering segment 115a, called cover 115a in the following, may easily be removed, for example when maintenance or repair work is to be performed on a zone-separating means 132. It is alternatively possible to design a cover 115a as a hinged cover, for instance with a pivot axis 115c and quick closures 115b accordingly only at the edges of the cover 115a running in the peripheral direction and at the edges of the pivot axis 115c in the peripheral direction, with opposite edges lying parallel to the axis.

It is indicated by a sealing cord 115d running all around that the cover 115a assumes an additional sealing function by resting tightly on the skeleton frame 116-110a.

The sealing element 115 may be made up of similar covers 115a distributed around the entire periphery. It is alternatively possible that a part of the covering element 115 be fastened undetachable to the skeleton frame 116-110a, mainly where accessibility to the skeleton frame 116-110a is not required. It would in addition be possible to attach covers directly to the fillers 132 and 117. In this case, of course, the additional sealing function of the covering element would be absent. However, then the covers may be used as supports of functional parts such as, for example, the connection fitting A2.

In the case of the special embodiment represented in FIG. 10, the connecting fitting A2 is fastened to the cover 115a and rests by a tubular piece 121 with the intermediary of a sealing element 123 on the fitting filler 117.

In FIG. 11, details of a filter cell 136′ according to FIG. 3 are represented and in particular the details of a filter means 138 inserted into a filter cell 136′. The filter means 138 comprises a supporting frame 138a, which is supported radially inward against the filter rotor 112 by an intermediate plate 138b and is sealed off against the cell-enclosing wall 136′ by a sealing ring 138c of the cell 136′. The sealing ring 138 at the same time rests on a supporting structure 138d. It is to be noted that the sealing ring 138c reaches approximately to a face 138e of the supporting frame 138a, so that between the supporting frame 138a and the cell-enclosing wall 136′a a slot 138f of very small radial depth exists, in any case, in which residues can easily be dissolved, for example by the aforementioned washing nozzle 168.

The supporting frame 138a is designed with a filter fabric 138g made of metal filaments, which is welded at 138h with the carrier frame 138a. Underneath the filter fabric 138g are formed relief filtrate discharge channels 138i in the supporting frame 138a, which lead to a filtrate outlet 138j. The filtrate outlet 138j is in communication via an opening 138k of the intermediate plate 138b with the discharge opening 140.

In FIG. 12, an additional embodiment is represented, which differs from the embodiment of FIGS. 4-11 by a modified bearing element of the filter rotor 212. Similar parts are provided with the same reference numerals as in FIGS. 4-11, increased by the number 100 in each instance

In the embodiment of FIG. 12, the filter rotor 212 is supported by a single rotor bearing element 222, specifically on the left side of the filter housing 210 in the figure. At the same time, the rotor bearing element 222 is supported by a separate rotor bearing element 225 on the base frame 213. No bearing is provided for the filter rotor 212 at the right hand end of the filter housing 210 in FIG. 12. Therefore, one speaks of a “flying bearing” of the filter rotor 212. The rotor bearing element 222 is relatively large in its axial extension and may be composed of a plurality of ball bearings, roller bearings or tapered roller bearings, so that bending moments resulting from the dead weight of the filter rotor 212 and from asymmetrically distributed pressures from the process media can be absorbed. In this embodiment, the introduction of bearing forces into the filter housing 210 is reduced thanks to the separator rotor bearing element 225. Therefore, the filter housing 210 even when it is exposed to considerable hydrostatic pressures, in particular interspace zones Z1-Z4, may be built relatively light.

It is to be noted that the rotating connection assembly 246 is located on the side of the rotor bearing element 222 away from the filter housing 210, so that the rotor bearing element 222 may be pressed on near the filter housing 210. The gear output shaft 254d is supported within the gear housing 254a by an output member bearing element 254i. For this reason, no uncompensated radial forces which may be exerted from the gear 254 on the gear output shaft 254d can be transmitted to the end section 224 of the filter rotor 212. In other respects, the embodiment of FIG. 12 corresponds with respect to the design of the filter rotor 212 and the filter housing 210 to the embodiment of FIGS. 4-11.

The embodiment of FIGS. 13 and 14 corresponds with respect to the flying bearing of the filter rotor to the embodiment of FIG. 12. Similar parts are provided with the same reference numerals as in FIG. 12 increased by the number 100, in each instance.

In this embodiment, the filter housing 310 is displaceable on a sliding frame 327 in the direction of the arrow 329 in the direction of the filter rotor axis A between an operating position according to FIG. 13 and a displaced position according to FIG. 14. The sliding frame 327 is again supported on the base frame 313.

What has been said concerning FIG. 12 with regard to the rotor bearing element 322 and rotor bearing supporting element 325 otherwise applies. With regard to the construction and mode of operation of the filter rotor 312 and the filter housing 310 the statements made in connection with FIGS. 4-11 apply.

When it becomes necessary to perform repair or maintenance work on the filter rotor 312 and/or on the interior of the filter housing 310, the filter housing 310 is shifted into the position according to FIG. 14. This is readily possible, thanks to the flying bearing element of the filter rotor 312 in the rotor bearing element 322. The sealing assemblies, which seal off the interspace between filter rotor 312 and filter housing 310 in the operating position of FIG. 13 at both ends, do not prevent displacement of the filter housing 310 when these sealing assemblies are constructed according to FIG. 9. One need only let the pressure out of the toric inflation members 134f (FIG. 9) and then shift the filter housing 310 without substantial friction into the sealing assembly. The filter rotor 312 remains in place in any case, so that problems do not arise either in the region of the rotor bearing element 322 or in the region of the rotary connection assembly 346 because of the displaceability of the filter housing 310.

It can be seen in FIG. 14 that the filter rotor 312 lies free. Otherwise, the interior of the filter housing 310 is accessible from its right end when the filter housing 310 is shifted into the position of FIG. 14.

The displaceability of the filter housing 310 of FIGS. 13 and 14 may be combined with the construction of the covering element 315, i.e., with covers which are detachable or which may be swung away, in order thereby optionally to further facilitate accessibility to particular functional parts of the rotating filter system.

The statements made in connection with FIG. 12 apply with regard to the static conditions of the rotor bearing element 322 and rotor bearing supporting element 325, as well as of the housing supporting element.

1. Rotating filter system, comprising
a filter housing having a housing casing unit,
a filter rotor with a rotor casing unit accommodated within the filter housing and capable of rotating about a rotor axis, an interspace between the rotor casing unit and the housing casing unit,
where the rotor casing unit has a plurality of filter cells or filter cell groups following one another in the peripheral direction, where additionally in individual filter cells a supply space opening toward the interspace is in each instance separated by a filter means from a discharge line system rotating with the filter rotor, to which in turn a stationary discharge line system is connected downstream via a rotating connection assembly, where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with one stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit which has an output member located substantially coaxial with the filter rotor and connected with the filter rotor for common rotation about the rotor axis,
characterized by
at least one of the two feature groups:
a) the output member is supported in an additional bearing in the following, called “output member bearing” which is supported stationary by an output member bearing element, separate from the rotor bearing element;
b) the output member is driven by a group of driving wheels, which are distributed around the periphery of the output member in such a way that the radial components of the forces transmitted to the output member are at least partially canceled out.

2. Rotating filter system according to claim 1, characterized in
that the rotor bearing is supported by means of the rotor bearing element and the output member bearing is supported by means of the output member bearing element on a common foundation or base frame.

3. Rotating filter system according to claim 1, characterized in
that the gear unit comprises a gear housing in which the gear output member is also supported and in that this gear housing is supported stationary by a gear housing bearing element.

4. Rotating filter system according to claim 1.
characterized in
that the gear unit comprises at least one planetary gear stage and in that the gear output member is part of the planetary gear stage.

5. Rotating filter system according to claim 1,
characterized in
that the rotor bearing is at least in part fastened to the gear housing and is supported stationary by means of the gear housing.

6. Rotating filter system according to claim 1,
characterized in
that the rotor bearing is supported by a rotor bearing element which keeps the filter housing substantially free of supporting forces.

7. Rotating filter system according to claim 1,
characterized in
that the rotor bearing has a bearing polenta in each of the end regions of the filter housing spaced apart along the rotor axis.

8. Rotating filter system according to claim 1,
characterized in
that the rotor bearing is limited to the end region of the filter housing near the gear unit.

9. Rotating filter system according to claim 1,
characterized in
that the rotor bearing has at least one rolling bearing or at least one group of rolling bearings.

10. Rotating filter system according to claim 1,
characterized in
that the output member of the gear unit is connected to the filter rotor via a compensating coupling flexible at least in the direction orthogonal to the rotor axis.

11. Rotating filter system according to claim 1,
characterized in
that the rotating connection assembly is located in the direction of the rotor axis between the filter housing and the output member bearing.

12. Rotating filter system according to claim 11,
characterized in
that the rotating connection assembly is located on the side of a rotor bearing point of the rotor bearing that is distant from the filter housing.

13. Rotating filter system according to claim 1,
characterized in
that the filter housing bearing element comprises, in at least one end region of the filter housing, a plurality of bearing points approximately uniformly distributed around the periphery of the filter housing.

14. Rotating filter system according to claim 1,
characterized in
that compensating means are assigned to at least some of the bearing points for the compensation of variations in diameter of the housing casing unit.

15. Rotating filter system according to claim 14,
characterized in
that a supporting column or a supporting beam for the filter housing is provided at each of two bearing points spaced apart along a horizontal diametrical line D.

16. Rotating filter system according to claim 1,
characterized in
that the filter housing bearing element has compensating means for variations in Length of the filter housing in the direction of the rotor axis.

17. Rotating filter system according to claim 1,
characterized in
that the interspace between the rotor casing unit and the housing casing unit is capable of being sealed off in the vicinity of at least one axial end of these units by a sealing assembly which is capable of being brought by a torus inflatable by means of pressure fluid into sealing contact with a sealing surface of at least one of the two units.

18. Rotating filter system according to claim 17,
characterized in
that the sealing assembly is connected stationary to the housing casing unit and is capable of being pressed against a sealing surface rotating with the rotor casing unit.

19. Rotating filter system according to claim 18,
characterized in
that the sealing assembly comprises a substantially U-shaped groove profile in cross section, which with respect to the housing casing unit is fixed by a first U arm, is capable of being sealingly pressed by a second U arm against the sealing surface of the rotor casing unit and between the two U arms accommodates a toric inflation member, which is located stationary on the housing casing unit and is connected to a pressure fluid source.

20. Rotating filter system according to claim 17,
characterized in
that the sealing assembly is attached to an end ring of an approximately cylindrical frame of the filter housing.

21. Rotating filter system according to claim 1,
characterized in
that filter housing comprises an approximately cylindrical skeleton frame having at least two terminal skeleton rings and, between the skeleton rings, skeleton rods running parallel to the axis of rotation, where this skeleton frame forms a basic structure of the housing casing unit and where in the skeleton window, between successive skeleton rods fliers are capable of being inserted as supports for functional parts of the filter system.

22. Rotating filter system according to claim 21,
characterized in
that a cover is assigned to at least one skeleton window.

23. Rotating filter system according to claim 22,
characterized in
that the cover is the support of at least one functional part of the filter system, which if desired cooperates with a filler or a functional part of the filter system supported by a filler.

24. Rotating filter system according to claim 22,
characterized in
that a cover is limited to covering a single filler.

25. Rotating filter system according to claim 22,
characterized in
that a cover is designed for covering a plurality of fillers.

26. Rotating filter system according to claim 22,
characterized in
that a cover is capable of being fixed by linking and/or fastening means to the skeleton frame.

27. Rotating filter system according to claim 22,
characterized in
that the cover is capable of being fixed by linking or/and fastening means to a filler.

28. Rotating filter system according to claim 22,
characterized in
that the cover is capable of pivoting about a pivot axis parallel to the rotor axis.

29. Rotating filter system according to claim 22,
characterized in
that the cover is part of an annular closed covering of the housing casing unit.

30. Rotating filter system according to claim 1,
characterized in
that the interspace, the supply line system, the rotating discharge line system and the stationary discharge line system are sealed against escape of filter process medal and against entry of fouling substances, in particular lubricants.

31. Rotating filter system according to claim 1,
characterized in
that a zone-separating means is made of a separating plate on whose side distant from the rotor casing unit rests a membrane acted on by a pressure fluid or a cushion acted on by a pressure fluid.

32. Rotating filter system according to claim 1,
characterized in
that the zone-separating means comprise a separating plate having a strip of synthetic material and a sealing layer attached to the strip.

33. Rotating filter system according to claim 1,
characterized in
that a filter means assigned to a filter cell comprises a supporting frame, preferably a supporting frame of synthetic material, sealed off on its periphery against a cell-enclosing wall, for a filter fabric, screen or the like, where a sealing ring used for sealing sealingly fills up the interspace between a peripheral surface of the supporting frame and the cell-enclosing wall to approximately the level of a filter-side face of the supporting frame on the periphery.

34. Rotating filter system according to claim 1,
characterized in
that the filter fabric is a metal wire fabric, which is welded to a supporting frame.

35. Rotating filter system according to claim 1,
characterized in
that the filter housing, for at least partial freeing of the filter rotor is displaceable relative to the filter rotor in the direction of the axis of rotation.

36. Rotating filter system according to claim 35,
characterized in
that the filter housing is carried displaceable on a stationary displacing frame.

37. Rotating filter system according to claim 1,
characterized in
that cleaning nozzles, which are connected to a cleaning fluid supply, are provided in the region of functional parts requiring cleaning.

38. Rotating filter system according to claim 1,
characterized in
that a filter cake ejection zone is provided in the lowest region of the housing casing.

39. Rotating filter system, comprising
a filter housing having a housing casing unit,
a filter rotor with a rotor casing unit accommodated within the filter housing and capable of rotating about a rotor axis,
an inter-space between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that the gear unit comprises at least one planetary gear stage and in that the gear output member is a part of the planetary gear stage.

40. Rotating filter system comprising
a filter housing having a housing casing unit,
a filter rotor with a rotor casing unit accommodated within the filter housing and capable of rotating about a rotor axis,
an interspace between the rotor casing unit and the housing casing unit,
where the rotor casing unit has a plurality of filter cells or filter cell groups following one another in the peripheral direction, where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace undivided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that the rotor bearing has at least one rolling bearing or at least one group of rolling bearings.

41. Rotating filter system, comprising a filter housing having a housing casing unit,
a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that the rotor bearing is limited to the end region of the filter housing near the drive unit.

42. Rotating filter system, comprising
a filter housing having a housing casing unit, a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that the rotating connection assembly is located in the direction of the rotor axis between the filter housing and the drive member bearing.

43. Rotating filter system, comprising
a filter housing having a housing casing unit,
a filter rotor with a rotor casing unit accommodated within the filter housing and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of belong driven by a drive motor via a gear unit, which has an output
member located substantially coaxial with the filter rotor and connected with the filter rotor for common rotation about the rotor axis,
characterized in
that the filter housing support, at least in one end region of the filter housing comprises a plurality of bearing points distributed approximately uniformly around the periphery of the filter housing.

44. Rotating filter system, comprising
a filter housing having a housing casing unit,
a filter rotor with a rotor casing unit accommodated within the filter housing and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member substantially coaxial with the filter rotor and connected with the filter rotor for common rotation about the rotor axis,
characterized in
that a supporting column or a supporting beam is provided for the filter housing at each of two bearing polentas spaced apart along a horizontal diametral line D.

45. Rotating filter system, comprising
a filter housing having a housing casing unit,
a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction, where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis
characterized in
that the interspace between the rotor casing unit and the housing casing unit is capable of being sealed off in the vicinity of at least one axial end of these units by a sealing assembly, which is capable of being brought by a torus inflatable by means of pressure fluid into sealing contact with a sealing surface, of at least one of the two units.

46. Rotating filter system, comprising
a filter housing having a housing casing unit,
a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that a filter means assigned to a filter cell comprises a supporting frame, preferably a supporting frame of synthetic material, sealed off at its periphery against a cell-enclosing wall for a filter fabric, screen or the like, where a sealing ring used for sealingly sealing fills up the interspace between a peripheral surface of the supporting frame and the cell-enclosing wall to approximately the level of a filter material-side face of the supporting frame near the periphery.

47. Rotating filter system according to claim 45,
characterized in
that the filter housing, for at least partial freeing of the filter rotor is displaceable relative to the filter rotor in the direction of the axis of rotation.

48. Rotating filter system, comprising
a filter housing having a housing casing unit, a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that a filter cake ejection zone is provided in the lowest region of the housing casing.

49. Rotating filter system, comprising
a filter housing having a housing casing unit, a filter rotor with a rotor casing unit accommodated within the filter housing, and capable of rotating about a rotor axis,
an interspace between the rotor casing unit and the housing casing unit,
where the rotor casing unit has a plurality of filter cells or filter cell groups following one another in the peripheral direction,
where additionally in separate filter cells a supply space opening toward the interspace is in each instance separated by a filter means from a discharge line system rotating with the filter rotor, to which in turn a stationary discharge line system is connected downstream via a rotating connection assembly,
where additionally the interspace is divided by zone-separating means into a plurality of interspace zones following one another in the peripheral direction, which upon rotation of the filter rotor successively come into communication with separate filter cells or filter cell groups and at least some are in communication with a stationary supply line system, so that at least one stationary supply line of the stationary supply line system, via an associated stationary interspace zone and in each instance at least one of the filter cells or filter cell groups successively traveling past this interspace zone and rotating discharge lines of the rotating discharge line system in each instance assigned to the individual filter cells or filter cell groups is in communication with a stationary discharge line of the stationary discharge line system assigned to this stationary supply line,
where additionally the filter rotor is supported by a rotor bearing and this rotor bearing is supported stationary by a rotor bearing element,
where additionally the filter rotor is capable of being driven by a drive motor via a gear unit, which has an output member located substantially coaxial with the filter rotor and connected with the filter rotor for common rotation about the rotor axis,
characterized in
that cleaning nozzles, which are connected to a cleaning fluid supply, are provided in the region of functional parts requiring cleaning.
